(19) United States
(12) Patent Application Publication
(10) Pub. No.: US 2010/0070967 A1
(43) Pub. Date: Mar. 18, 2010

(54) Recording medium of network administration program

(75) Inventor: Takayuki Doui, Osaka (JP)

Correspondence Address: BUCHANAN, INGERSOLL & ROONEY PC, POST OFFICE BOX 1404, ALEXANDRIA, VA, 22313-1404, US

(73) Assignee: Minolta Co., Ltd., Osaka (JP)

(21) Appl. No.: 12/591,388

(22) Filed: Nov. 18, 2009

Related U.S. Application Data
(62) Division of application No. 10/397,264, filed on Mar. 27, 2003, now abandoned.

(30) Foreign Application Priority Data
Mar. 27, 2002 (JP) 2002-88414

(51) Int. Cl. G06F 15/177; G06F 9/44

(52) U.S. Cl. 717/173; 709/221

(57) ABSTRACT

In accordance with a network administration program that is stored on a prescribed device on a network and is run in order to manage the various devices connected to the network, it is determined whether or not a new device has been connected to a prescribed administered zone of the network, and if it is determined that a new device has been connected to the network, it is determined whether or not an update file for the network administration program exists in the storage area of the new device, and if it is determined that an update file exists, the update file is read from the new device to the device on which the network administration program is stored.

This application is based on application No. 2002-88414 filed in Japan, the content of which is hereby incorporated by reference.

### BACKGROUND OF THE INVENTION

1. Field of the Invention

This invention pertains to a program that manages devices connected to a network, and more particularly to a network administration program that includes an upgrade or update management function with regard to programs incorporated in the devices connected to the network.

2. Description of the Related Art

As is known in the art, in order for the various devices connected to a network to operate properly, the versions of the programs incorporated in such devices must be compatible with each other. In this regard, in the conventional art, systems have been proposed, for example, wherein when a new computer is connected to the network and a floppy is inserted into the drive of the connected computer and booted, an OS (Operating System) or the like is read from an installation server on the network and installed (see Japanese Laid-Open Patent Application H 8-87460, which corresponds to U.S. Pat. No. 5,978,590), and wherein a revision monitoring server reviews the revision history in a database, and if a revision has occurred, the client program is notified of the contents of the revision and the revision is reflected in the operation of the client program (Japanese Laid-Open Patent Application 2001-76465).

However, in the conventional systems described above, because the program residing on the installation server or the revision monitoring server is not limited to the newest version, if a device that contains a newer version of such a program that is incompatible with the program residing on the installation server or the revision monitoring server is connected to the network, the problem arises that the network cannot be administered in a satisfactory fashion.

### SUMMARY OF THE INVENTION

According to one aspect of the present invention, a recording medium on which is stored a computer-readable network administration program that manages devices connected to a network, wherein the network administration program comprises steps of: determining whether or not a device has been newly connected to the network; determining, when it is determined that the device has been newly connected to the network, whether or not an update file for the network administration program exists in a storage area of the device; and reading the update file from the newly connected device to the administration device, when it is determined that the update file exists.

According to another aspect of the present invention, a computer-readable recording medium of network administration program for managing one or more devices connected to a network, wherein the program comprises steps of: detecting a device newly connected to the network; determining, when the device is detected, whether or not an update file for the network administration program exists on the detected device; and reading out the update file from the newly connected device, when it is determined that the update file exists.

### BRIEF DESCRIPTION OF THE DRAWINGS

These and other objects and features of this invention will become clear from the following description, taken in conjunction with the preferred embodiments with reference to the accompanied drawings in which:

FIG. 1 is a drawing showing a schematic diagram of a network in which network administration is implemented using a network administration program;

FIG. 2 is a drawing explaining an update function of the above network administration program;

FIGS. 3-6 show flow charts of update operations of the above network administration program; and

FIG. 7 shows a flow chart of a processes performed with regard to program data residing in a storage area of a new device that is not administered by the above network administration program.

### DETAILED DESCRIPTION OF THE PREFERRED EMBODIMENTS

An embodiment of the present invention will be described in detail below with reference to the attached drawings.

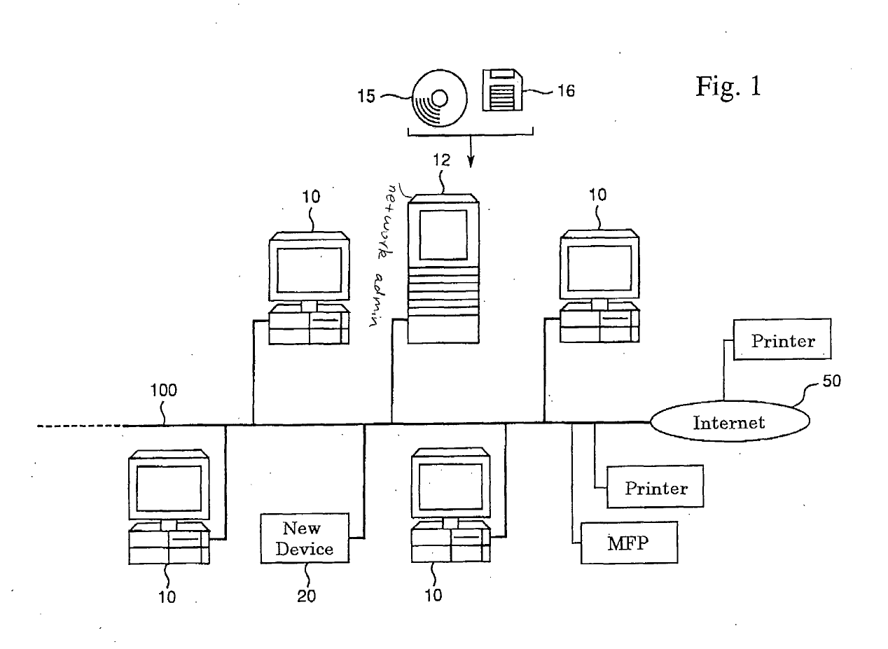

FIG. 1 shows the schematic diagram of a network in which network administration of a first embodiment is implemented. Connected to this network 100 are a computer (hereinafter referred to as a ‘network administration device’) 12 that performs network administration, multiple client computers 10, and one or more printing devices such as printers 11 and MFPs 12. A new device 20 is then connected to the network 100. The new device may be a printer that outputs data sent from a client computer 10 through printing, a network-compatible digital copier or an MFP (multi-function peripheral). Furthermore, the network 100 is connected to the Internet 50, and services such as file downloading can be used by the network administration device 12 and the client computers 10, based on various protocols and methods, such as file sending via e-mail or FTP, HTTP, etc.

A network administration program resides in the network administration device 12, which based on this program performs overall control and administration of the network and carries out other tasks such as searches for files requested by other devices. The network administration program may be an administration program that manages in a comprehensive fashion all printers, MFPs and the like that are connected to the network. This network administration program is normally installed on the hard disk (not shown) of the network administration device 12 via an external recording medium such as a CD-ROM 15 or a floppy disk 16 (see FIG. 1), and is called up and executed from a prescribed memory area when necessary.

In this embodiment, a program that manages printing devices such as printers and MFPs that are connected to the network is described as an example of the network administration program. A new device such as a printer, for example may be newly connected to the network. One of the network administration functions incorporated in the network administration program is an update function with regard to the programs residing on the various devices connected to the network 100, and in particular, where a new device 20 is connected to the network 100, this function ensures proper interoperability among the various devices and, where necessary, automatically updates the programs residing on the various devices including the network administration device 12.

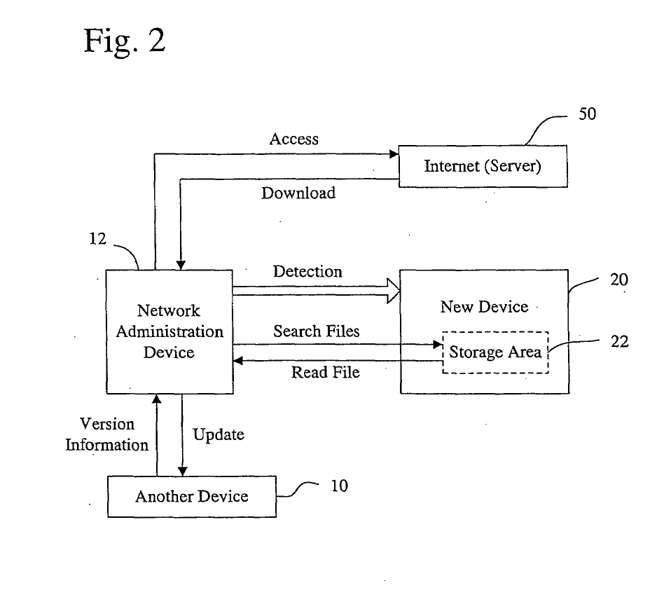

FIG. 2 describes the update function of the network administration device 12 executed over the network 100. When executing the update function, where a new device 20 is discovered, the network administration device 12, based on the network administration function, first searches in the storage area 22 of the storage medium of the new device 20, such as a memory, hard disk or the like, for the update file for the network administration program residing on the network administration device 12. If the update file is found, where the version associated with that update file is newer than the version of the program currently being used, the network administration device 12 reads the update file from the storage area 22 of the new device 20 and automatically updates the network administration program.

Furthermore, the network administration device 12 receives from the client computers and other devices 10 on the network 100 information including version information regarding the programs residing on the other devices 10, as well as searches the storage area 22 of the new device 20 for update files for the programs residing on the other devices 10. If an update file is found, where the current version is older than the version of the update file residing in the storage area 22, the network administration device 12 reads the update file from the storage area 22 of the new device 20, sends it to the other devices 10, and automatically updates the programs residing on the other devices.

Where a program update file is not found in the storage area 22 of the new device 20, the network administration device 12 searches the storage area 22 of the new device 20 for a file that contains the URL that specifies the storage location for the newest version of the program. If a file that contains the URL that specifies the storage location for the newest version of the program is found, the network administration device 12 accesses the Internet 50 and downloads the update program from a server 51 such as an FTP server or a Web server. After downloading is completed, the network administration device 12 automatically updates the program. Where the program is present on other devices, the update file is sent to the other devices 10 after downloading and updating is automatically performed.

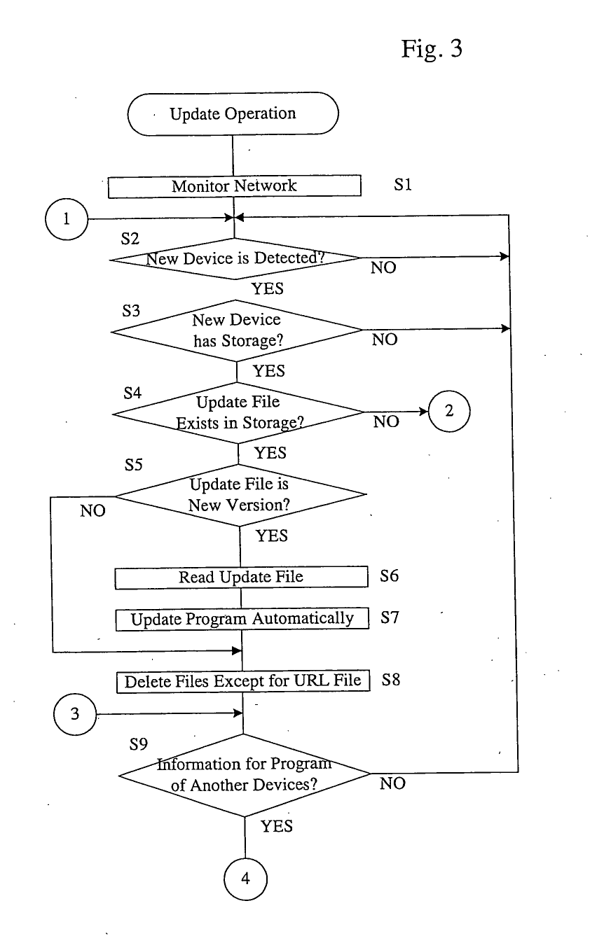

The update operation carried out by the network administration program stored on the network administration device 12 will now be described with reference to the flow charts shown in FIGS. 3-6. The routines shown in these flow charts are executed at prescribed intervals, for example. In this operation, the network administration device 12 monitors the administered zone of the network 100 (step S1), and determines whether or not a new device 20 has been connected to the network (step S2). If it is determined that a new device 20 has been connected to the network, the network administration program advances to step S3, while if it is determined that a new device 20 has not been connected to the network, the process of step S2 is repeated.

In step S3, it is determined whether or not the new device 20 has a storage area 22. If it is determined that the new device 20 has a storage area 22, the network administration program proceeds to step S4, while if it is determined that the new device 20 does not have a storage area 22, the network administration program returns to step S2.

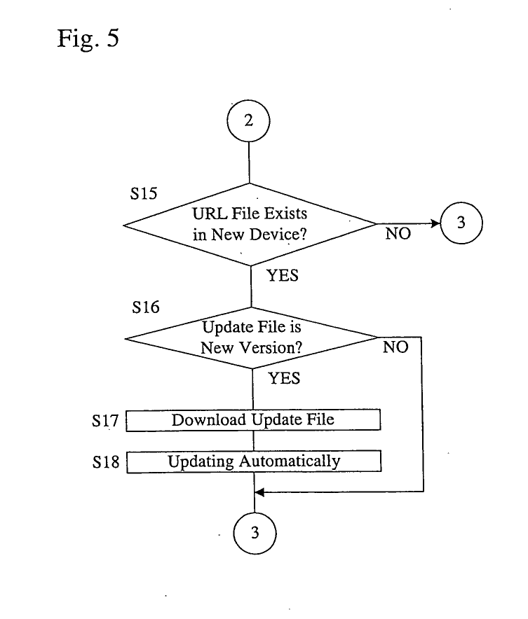

In step S4, it is determined whether or not an update file for the network administration program exists in the storage area 22 of the new device 20. If it is determined that an update file for the network administration program exists in the storage area 22 of the new device 20, the network administration program proceeds to step S5, while if it is determined that an update file for the network administration program does not exist in the storage area 22 of the new device 20, the network administration program advances to step S15 shown in FIG. 5.

In step S5 shown in FIG. 3, the version that would exist if updating were performed using the update file residing in the storage area 22 of the new device 20 is compared with the version of the currently used network administration program. If it is determined that the version of the currently used network administration program is older, the network administration program proceeds to step S6 to carry out update processing, while if it is determined that the current version is newer, the network administration program jumps to step S8.

In step S6, the update file is read from the new device 20, and updating is then performed automatically in step S7 using this update file. The network administration program then proceeds to step S8.

In step S8, of the program-related data, files other than the file containing the URL that specifies the storage location for the update file for the newest version are deleted from the storage area 22 of the new device 20.

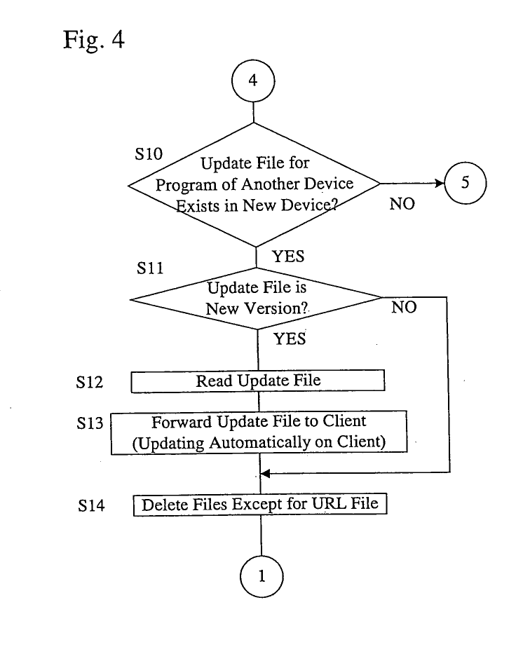

In step S9, it is determined whether or not information (such as location information or version information) pertaining to a prescribed program used in devices other than the administration device 12, such as client computers 10, is included in the network administration program. If it is determined that information pertaining to a prescribed program used in client computers 10 is included in the network administration program, the network administration program proceeds to step S10 shown in FIG. 4, while if it is determined that such information is not included in the network administration program, the network administration program returns to step S2 shown in FIG. 3 and the processes including and subsequent to that step are executed once again.

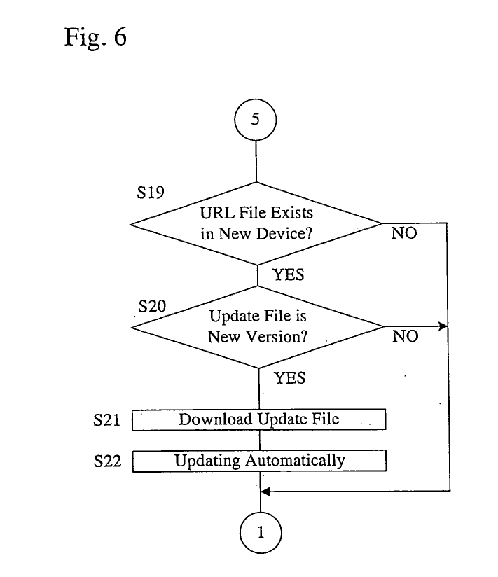

In step S10 shown in FIG. 4, it is determined whether or not an update file for a program used in client computers exists in the storage area 22 of the new device 20. If it is determined that an update file for a program used in client computers 10 exists, the network administration program proceeds to step S11, while if it is determined that an update file for a program used in client computers 10 does not exists, the network administration program jumps to step S19 shown in FIG. 6.

In step S11, the program version after updating is performed using the update file residing in the storage area 22 of the new device 20 is compared with the version of the program currently used in the client computers 10. If it is determined that the current version is older, the network administration program proceeds to step S12, while if it is determined that the current version is newer, the network administration program advances to step S14.

In step S12, the update file is read from the new device 20 and forwarded to the client computers 10, whereupon updating is automatically performed on the client computers 10 (step S13). The network administration program then advances to step S14.

In step S14, files other than the file containing the URL that specifies the storage location for the update file for the newest version are deleted from the storage area 22 of the new device 20. The network administration program then returns to step S2 shown in FIG. 3 and the processes including and subsequent to that step are executed once again.

In step S15 shown in FIG. 5, it is determined whether or not a file that indicates the URL that specifies the storage location for an update file for the newest version of the network administration program exists in the storage area 22 of the new device 20. If it is determined that a file indicating such URL exists in the storage area 22, the network administration program proceeds to step S16, while if it is determined that a file containing the URL does not exist, the network administration program returns to step S9 shown in FIG. 3 and the processes including and subsequent to that step are executed once again.

In step S16, the program version after updating is performed using the update file residing in the storage location specified by the above URL is compared with the current version of the program. If it is determined that the current version is older, the network administration program proceeds to step S17, while if it is determined that the current version is newer, the network administration program returns to step S9 shown in FIG. 3 and the processes including and subsequent to that step are executed once again.

In step S17, the update file is read from the storage location specified by the URL, and updating is then performed automatically in step S18 using this update file. The network administration program then returns to step S9 shown in FIG. 3 and the processes including and subsequent to that step are executed once again.

Where it is determined in step S10 that an update file for a program used in other devices 10 does not exists in the storage area 22 of the new device 20, it is determined in step S19 shown in FIG. 6 whether or not a file indicating the URL specifying the storage location for an update file for the newest version of a program being used in the other device 10 exists in the storage area 22. If it is determined that such a file exists, the network administration program proceeds to step S20, while if it is determined that such a file does not exist, the network administration program returns to step S2 shown in FIG. 3 and the processes including and subsequent to that step are executed once again.

In step S20, the version after updating using the update file for the newest version that resides in the storage location specified via the above URL is compared with the current version. If it is determined that the current version is older, the network administration program proceeds to step S21, while if it is determined that the current version is newer, the network administration program returns to step S2 shown in FIG. 3 and the processes including and subsequent to that step are executed once again.

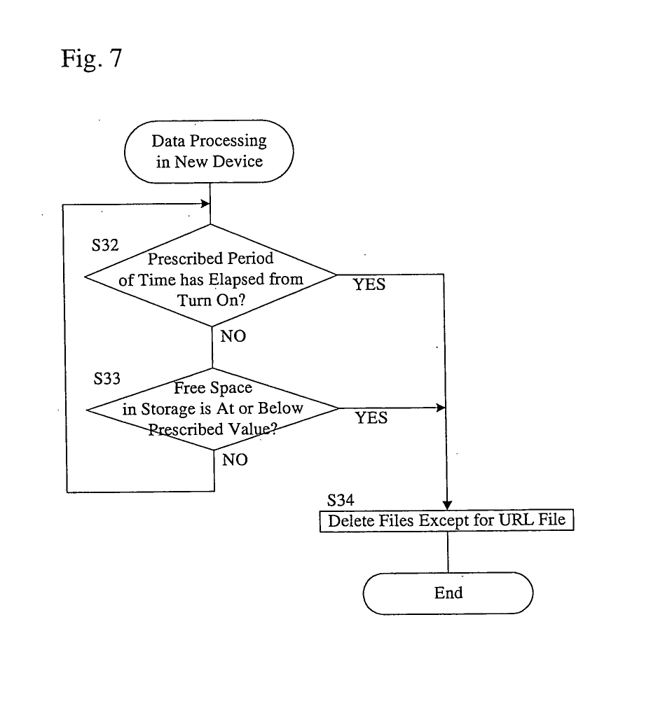

In step S21, the update file is read from the above URL, and updating is automatically performed in step S22 using the update file. Following the operation of step S22, the network administration program returns to step S2 shown in FIG. 3 and the processes including and subsequent to that step are executed once again.

Where administration by the network administration program described above is not performed, such as where the device 20 such as a printer or the like is not connected to the network 100, or where no network administration device 12 exists on the network to which the new device 20 is connected, there is a danger that the device itself will not function properly if program-related data such as the update file remains in the storage area 22 of the new device 20. In order to eliminate this problem, processing of the program-related data in the storage area 22 of the device 20 has been considered, as shown in FIG. 7. In other words, if a prescribed period of time has elapsed after power supply to the device has been turned ON, or if the amount of free space in the storage area is at or below a prescribed value, the update program is deleted. However, the file indicating the URL that specifies the storage location for the update file for the newest version is left.

In FIG. 7, this program is executed when the power supply to the new device 20 is turned ON. First, it is determined whether or not a prescribed period of time has elapsed (step S32). If it is determined that a prescribed period of time has not elapsed, the network administration program proceeds to step S33, while if it is determined that a prescribed period of time has elapsed, the network administration program advances to step S34.

In step S33, it is determined whether or not the amount of free space in the storage area 22 is at or below a prescribed value. If it is determined that the amount of free space is not at or below a prescribed value, the network administration program returns to step S32, while if it is determined that the amount of free space is at or below a prescribed value, the network administration program proceeds to step S34.

In step S34, files other than the file containing the URL that specifies the storage location for the update file for the newest version are deleted from the storage area 22, whereupon processing ends.

Through the processing described above, the problem of being unable to increase the amount of free space in the storage area 22 with an update file being stored on the new device 20 is eliminated, and the amount of free space in the storage area 22 in the new device 20 can be increased while preserving the state in which the update file can be used.

Moreover, the present invention is not limited to the implementation described above, and needless to say, various improvements and design changes may be made without deviating from the essential scope of the invention.

As is clear from the above description, where it is confirmed that a device such as a printer or MFP is newly connected to a network that is administered by the network administration program, the update file used to update the network administration program is read from the storage area of the new device and updating is performed, thereby permitting updating to be carried out at all times without problem or difficulty.

In addition, the need for updating of the network administration program can be easily determined, and where updating is determined to be necessary, updating can be automatically performed.

Moreover, where a new device is connected to the network, other devices on the network (client computers or the like) can be updated automatically.

In addition, the need for updating of a current program stored on client computers can be easily determined, and where updating is determined to be necessary, updating can be automatically performed.

Furthermore, even if a device newly connected to the network does not have an update file, if a file indicating a URL that specifies the storage location for the update file for the newest version is stored thereon, the program can be updated using that URL.

In this way, where a device is newly connected to the network, update processing can be carried out where necessary, and a network administration program that enables good interoperability of the network administration device and the various devices such as client computers connected to the network can be provided.

Obviously, many modifications and variation of the present invention are possible in light of the above teachings. It is therefore to be understood that within the scope of the appended claims, the invention may be practiced other than as specifically described.

What is claimed is:

1. A recording medium on which is stored a network administration program that manages devices connected to a network, wherein the network administration program comprises the steps of:
determining whether or not a device has been newly connected to the network as a node of the network;
determining, when it is determined that the device has been newly connected to the network, whether or not an update file for a program used on a device other than an administration device connected to the network exists in a storage area of the newly connected device, and
distributing the update file to the device other than the administration device after reading the update file, when it is determined that the update file exists.

2. The recording medium on which is stored a network administration program according to claim 1, wherein the network administration program further comprises the steps of:
determining, based on version information, whether or not a current program stored on the device other than the administration device connected to the network needs to be updated, prior to reading of the update file for the program used in the device from the storage area of the newly network-connected device, and
carrying out the updating when it is determined that the current program needs to be updated.

3. The recording medium on which is stored a network administration program according to claim 1, wherein the network administration program further comprises the steps of:
determining whether or not a file indicating a URL that specifies a location for the update file on the Internet exists in the storage area of the newly network-connected device, when it is determined that the update file for the program used in the device other than the administration device does not exist, and
downloading the update file from the specified location and forwarding the downloaded update file to the device other than administration device, when it is determined that the file exists.
